(19) United States
(12) Patent Application Publication
(10) Pub. No.: US 2022/0230091 A1
(43) Pub. Date: Jul. 21, 2022

(54) SEGMENT-SPECIFIC MODEL TRAINING AND INFERENCE

(71) Applicant: SAP SE, Walldorf (DE)

(72) Inventor: Manikandan Rajasekar, Wiesloch (DE)

(21) Appl. No.: 17/151,852

(22) Filed: Jan. 19, 2021

(51) Int. Cl. G06N 20/00; G06N 5/04; G06F 16/28

(52) U.S. Cl. CPC G06N 20/00; G06F 16/284; G06N 5/04

(57) ABSTRACT

Systems and methods include reception of a training request comprising an object type and a target, determination of a plurality of segments associated with the object type based on a plurality of object instances of the object type, determination, for each of the plurality of segments, determine an associated plurality of object instances of the object type, and, for each of the plurality of segments, train a respective model to infer a value of the target based on the plurality of object instances associated with the segment.

### BACKGROUND

Modern database systems store vast amounts of data for their respective enterprises. Applications and other logic may access this stored data in order to perform various functions. Functions may include estimation or forecasting of data values based on stored data. Such estimation or forecasting is increasingly provided by trained neural networks, or models.

A model may be trained to infer a value of a target (e.g., delivery date) based on a set of inputs (e.g., fields of a specific sales order). The training may be based on historical data (e.g., a large number of sales orders and their respective delivery dates). The trained model may be referred to as an inference model and utilizes learned patterns in the historical data to infer a target value (e.g., a delivery date) from future data (e.g., a new sales order).

The accuracy of a trained model is influenced by the volume and relevance of historical data used to train the model. Limited training data leads to overfitting of the learned patterns and inability to accurately infer values from varied input data. Moreover, if a large percentage of the historical data exhibits a specific variance (e.g., Country=Germany), then the trained model might not accurately infer a result based on input data of a different variance (e.g., Country=France).

A large volume of historical training data may also adversely affect performance of the resulting trained model. For example, training a model based on one billion historical data records requires a significant amount of time. This leads to long user wait times and reduces the frequency with which the model can be updated. In addition, such training results in a complex trained model artefact which requires significant time to compute a target value.

Many enterprises restrict data access across geographic regions and/or enterprise units. Accordingly, it is desirable to limit a user to only models which have been trained using data to which the user also has access. Conventional systems may attempt to address this issue by manually applying controlled data filters during training, which is tedious, error-prone and time-consuming.

Systems are desired to address one or more deficiencies in conventional model training and usage.

### BRIEF DESCRIPTION OF THE DRAWINGS

FIG. 1 is a block diagram of an architecture to determine data segments and train segment-specific inference models according to some embodiments.

FIG. 2 is a block diagram of an architecture to identify and execute a trained segment-specific inference model based on an inference request according to some embodiments.

FIG. 3 is a flow diagram of a process to determine data segments and train segment-specific inference models according to some embodiments.

FIG. 4 is a flow diagram of a process to identify and execute a trained segment-specific inference model based on an inference request according to some embodiments.

FIG. 5 is a block diagram of an architecture to generate and use segment-specific trained inference models according to some embodiments.

FIG. 6 illustrates a user interface of a model training management application according to some embodiments.

FIG. 7 illustrates a user interface to configure generation of segment-specific trained inference models according to some embodiments.

FIG. 8 is a block diagram of a multi-model manager component according to some embodiments.

FIG. 9 is a flow diagram of a process to determine segments based on stored object instance data according to some embodiments.

FIG. 10 illustrates generation of segments based on segment groups according to some embodiments.

FIG. 11 is a flow diagram of a process to determine a segment and a corresponding trained model based on an inference request according to some embodiments.

FIG. 12 is a block diagram of a hardware system providing training and inference management according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments operate to train multiple models to perform a same task based on different sets, or segments, of historical data. In response to a request to perform the task with respect to new data, a segment to which the new data belongs is identified, and a model which has been trained using historical data of the identified segment is also identified. The identified model is then used to perform the task based on the new data. In some embodiments, the segment identification and model identification are transparent to the requestor.

According to some embodiments, segments are automatically determined based on historical data. For example, a request may be received to train a model to output a target value based on instance data of an object (e.g., a particular sales order conforming to a sales order object). In response, historical instance data of the object is acquired and a plurality of segments are determined (defined) based on the historical instance data. For each segment, a corresponding subset of the historical instance data is identified. Next, for each segment, a model is trained to output the target based on the subset of the historical instance data corresponding to the segment.

FIG. 1 is a block diagram of an architecture of system 100 according to some embodiments. The illustrated elements of system 100 may be implemented using any suitable combination of computing hardware and/or software that is or becomes known. Such a combination may include implementations which apportion computing resources elastically according to demand, need, price, and/or any other metric. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service).

Generally, training management system 110 receives training requests from technical administration system 120. The training requests may comprise requests to train a model to output a particular target based on an instance of an object. A training request according to some embodiments may include additional information which will be described below.

An object may comprise metadata describing the structure of data which defines a corresponding logical entity, while an object instance comprises data conforming to the structure and specific to a single instance of the logical entity. For example, system 100 may support a SalesOrder object type and historical instance data 135 of datastore 130 may comprise data associated with each of many specific sales orders. Datastore 130 may comprise metadata defining the SalesOrder object but embodiments are not limited thereto. Historical instance data 135 may comprise data associated with object instances of other object types.

In response to a training request, but not limited thereto, training management system 110 executes segment determination component 112 to determine segments based on historical data of object instances. Segments may be defined for a particular object and particular target. Therefore, for a same object, different segments may be defined for different targets.

In some embodiments, determination of a segment is based on object fields which have been previously marked as relevant to segmentation. Such fields may include custom object fields. In some embodiments, the training request may indicate whether or not a custom field should be considered relevant to segmentation. Segments associated with an object and target may be determined such that the historical object instances belonging each segment are statistically significant as well as statistically similar (e.g., count, distribution). Determination of a segment according to some embodiments will be described in detail below.

A segment may be defined by a set of fields and corresponding values such that all object instances having the corresponding field values belong to the segment. Segment registry 114 may store data defining each segment determined by segment determination component 112, as well as the object and target associated with each segment. As will be described below, segment registry 114 may also store data for facilitating identification of a segment to which new object instance data belongs.

Training management system 110 instructs training service 140 to train, for each determined segment, a respective model to output the requested target. The training instruction may include other information specifying characteristics of the model to be trained and/or the training process. In some embodiments, training service 140 stores a plurality of training scenarios which specify hyperparameters of models associated with various targets, initial node weights of the models and objective functions used to train the models. The instruction received by training service 140 from training management system 110 may therefore identify a training scenario and the determined segments to be used for training respective models.

In response to the instruction, training service 140 receives object instance data respectively corresponding to each segment from historical instance data 135. For example, it is assumed that segments 1, 2 and 3 have been identified by segment determination component 112 based on historical instance data 135. Historical instance data 135 which belongs to segment 1 (i.e., “SEGi”) is retrieved by training service 140 and used to train model M₁ using known training techniques. Generally, target values output by model M₁ for each object instance of SEGi are compared to “ground truth” target values for each object instance and internal node weights of model M₁ are adjusted until a aggregated difference, or total loss, between the output target values and the ground truth target values is below a threshold. At this point, model M₁ is considered trained.

Similarly, historical instance data 135 which belongs to segment 2 (i.e., “SEG₂”) is retrieved by training service 140 and used to train model M₂, and historical instance data 135 which belongs to segment 3 (i.e., “SEG₃”) is retrieved by training service 140 and used to train model M₃. Segment registry 114 may associate each determined segment with an identifier of a model which was trained based on historical instance data associated with the segment. Continuing the above example, segment registry 114 may associate segment 1 with model M₁, segment 2 with model M₂, and segment 3 with model M₃.

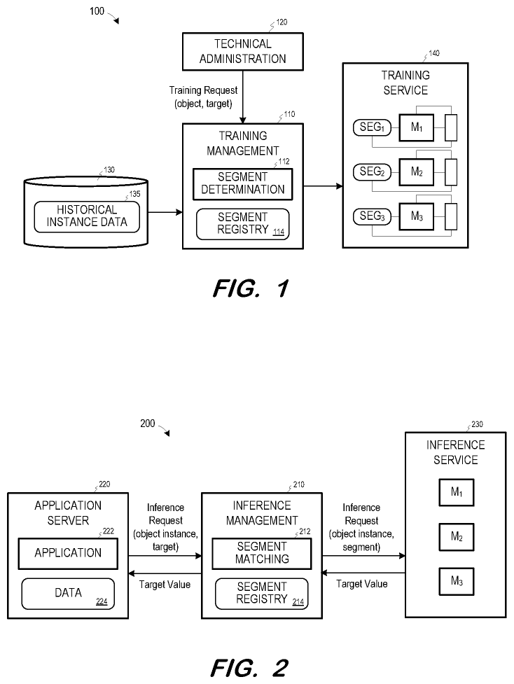

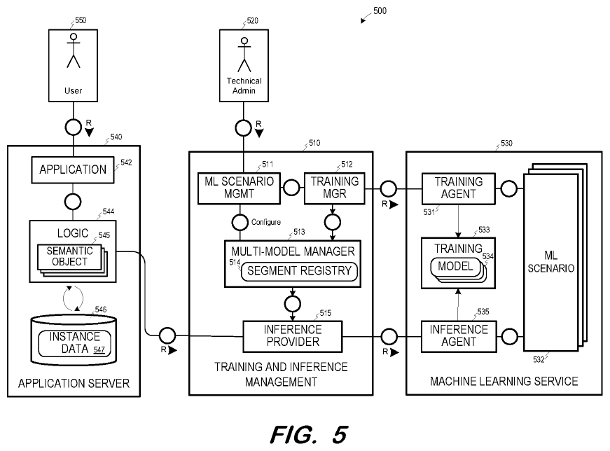

FIG. 2 is a block diagram of an architecture of system 200 according to some embodiments. The illustrated elements of system 200 may be implemented in any manner as described above with respect to system 100. In some embodiments as will be described below with respect to FIG. 5, a same computing system may perform the functions attributable to components of system 100 and system 200. For example, inference management system 210 and training management system 110 may comprise a single system, application server 220 and datastore 130 may comprise a single system, and inference service 230 and training service 140 may comprise a single service. In some embodiments, inference management system 210 and training management system 110 are provided to customers along with application server 220 for use thereby.

Inference management system 210 may operate to receive inference requests from application server 220. The inference requests may comprise requests to infer a value of a target based on data of an object instance. In response to the request, inference management system 210 executes segment matching component 212 to determine a segment to which the object instance belongs based on segment registry 214, to identify a trained model (i.e., an inference model) associated with the segment based on segment registry 214, and to forward a request to inference service 230 to infer the target value based on the object instance and using the identified trained model. Inference management system 210 receives the value from inference service 230 and returns the value to application server 220.

Application server 220 may comprise an on-premise or cloud-based server providing an execution platform and services to applications such as application 222. Application 222 may provide functions to users based on data 224. Data 224 may be stored in any suitable storage system such as a database system, which may be partially or fully remote from application server 220. Application 222 may create, read, update and delete data of data 224 based on a data schema consisting of semantic objects as is known in the art. For instance, data 224 may comprise relational database tables and views whose columns conform to a data schema defined by metadata stored in data 224. The data of object instances of a given semantic object may be stored in a same one or more database tables specified by the metadata.

Application 222 may call a service provided by application server 220 to generate an inference request. For example, application 222 may call the service to determine a target value based on an object instance. An inference request is created and transmitted to inference management system 210 in response, as shown in FIG. 2. Application 222 is therefore aware, for given object types, of the target or targets for which values may be inferred. In some embodiments, application 222 is aware of all training scenarios supported by inference management system 210, each of which is associated with an object type and a target.

Segment registry 214 may be identical to segment registry 114. As will be described below, segment registry 214 may include data structures to facilitate identification of a segment to which a particular object instance corresponds. Segment registry 214 may also associate each defined segment with an identifier of the trained inference model of inference service 230 which corresponds to the segment. In some embodiments, segment matching component 212 therefore uses registry 214 to identify a training scenario to which an inference request corresponds, to identify a segment of the training scenario to which an object instance of an inference request corresponds, and to identify a trained inference model of inference service 230 which corresponds to the segment.

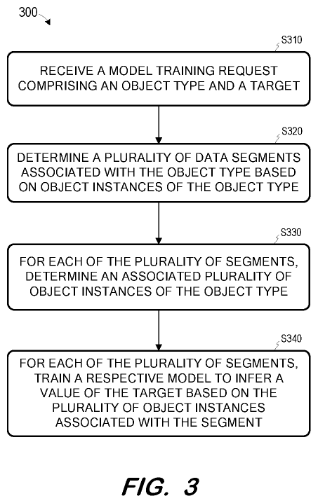

FIG. 3 comprises a flow diagram of process 300 to determine data segments and train segment-specific inference models according to some embodiments. Process 300 will be described with respect to the elements of system 100, but embodiments are not limited thereto.

Process 300 and all other processes mentioned herein may be embodied in processor-executable program code read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S310, a request is received to train a model. The request includes an object type and a target. The request may comprise a request to train a model according to a training scenario which in turn specifies an object type, a target, and any other suitable information defining the model and/or the training.

A plurality of data segments associated with the object type are determined at S320. The data segments are determined based on stored object instances of the object type. For example, if the object type is SalesOrder, the segments are determined based on instance data of a plurality of sales orders.

As described above, determination of the plurality of segments may be based on a subset of the fields of the object type. These fields may have been previously marked (e.g., by an application developer, user or both) in the object metadata as relevant to segmentation. Non-marked fields of the object type may therefore be ignored during S320.

For each of the plurality of data segments, an associated plurality of object instances are determined at S330. That is, the values of each stored object instance are analyzed to determine a segment to which the stored object instance belongs. In a simplified example, a first segment is determined at S320 to include all object instances for which Country=Germany and a second segment is determined at S320 to include all object instances for which Country=France. Accordingly, all stored object instances for which Country=Germany are determined to be associated with the first segment at S330, and all stored object instances for which Country=France are determined to be associated with the second segment at S330.

At S340, and for each of the plurality of segments, a respective model is trained to infer a value of the target. The respective model for a particular segment is trained based on the plurality of object instances determined at S330 to be associated with the segment. Continuing the above example, a first model associated with the first segment is trained using the stored object instances for which Country=Germany, and a second model associated with the second segment is trained using the stored object instances for which Country=France.

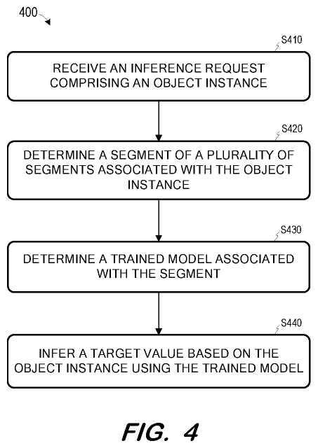

FIG. 4 is a flow diagram of process 400 to identify and execute a trained segment-specific inference model based on an inference request according to some embodiments. Process 400 may be performed by inference management system 210 of system 200 in some embodiments.

An inference request is received at S410. The inference request may comprise a request to infer a value of a target based on data of an object instance. Next, at S420, a segment associated with the object instance is determined. The segment associated with the object instance is determined from a plurality of segments. The plurality of segments may have been previously determined as described above, and may be defined (based on field values, ranges, etc.) within a registry or other data store. The data values of the object instance (i.e., the values of each field of the object instance) may therefore be evaluated against the definitions of each of the plurality of segments at S420 to determine the segment with which the object instance is associated. The plurality of segments may be associated with the object type of the object instance and the target, and therefore other pluralities of segments defined in the registry but associated with other object types and/or targets may be ignored.

S430 comprises determination of a trained model associated with the determined segment. The trained model is a segment-specific inference model and may be determined based on an identifier associating the trained model with the determined segment within the segment registry. Such an association may be generated after the training of such a model as described with respect to process 300.

A target value is inferred based on the object instance using the determined inference model at S440. The input to inference model is not limited to the above-described segmentation-relevant fields of the object instance in some embodiments. Rather, values of any or all of the fields of the object instance may be input to the inference model, so long as these fields were used during the training of the inference model. The inference model may be deployed by an inference service, which receives the object instance and performs the inference at S440 using the inference model.

FIG. 5 is a block diagram of system 500 to generate and use segment-specific trained inference models according to some embodiments.

Training and inference management system 510 may perform the above-described functions of training management system 110 and inference management system 210. Generally, training and inference management system 510 may receive a request from technical administrator 520 to train a model to infer a value of a target based on instance data of an object. In response, system 510 determines a plurality of segments based on the historical instance data of the object. System 510 then instructs machine learning service 530 to train, for each segment, a segment-specific model based on a subset of the historical instance data which is associated with the segment.

Training and inference management system 510 also receives requests from application server 540 to infer a target value based on object instance data. In response to this request, system 510 determines a plurality of pre-determined segments which correspond to the target and the object type of the object instance. System 510 then identifies one of the plurality of pre-determined segments to which the object instance corresponds based on the values of the object instance. A trained inference model of machine learning service 530 which corresponds to the identified segment is determined, and machine learning service 530 applies the trained model to the object instance to generate the requested target value. The target value is then returned to application server 540.

Training and inference management system 510 includes machine learning scenario management component 511 which is accessible by technical administrator 520. Technical administrator 520 interacts with component 511 to request and configure model training according to some embodiments. For example, technical administrator 520 may request model training based on a particular machine learning scenario which defines, for example, an input object type, a target, a model structure, initial node weights and an objective function.

The request may further include a request for training of segment-specific models. Such a request may include configuration information which influences segment determination and other aspects of multi-model handling. Accordingly, this configuration information is passed to multi-model manager 513, which maintains segment registry 514. As described above, segment registry 514 may include segment definitions and identifiers for each segment of a particular training request, and identifiers of the trained model associated with each segment.

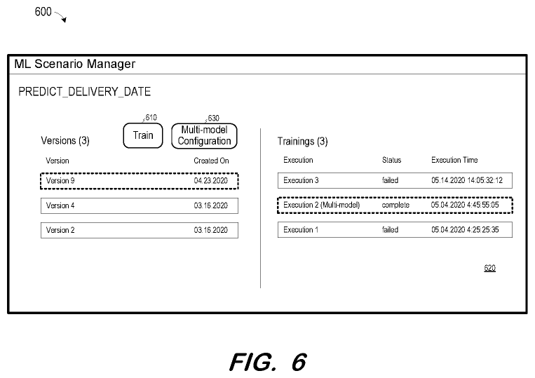

FIG. 6 illustrates user interface 600 of a model training management application such as machine learning scenario management component 511 according to some embodiments. Technical administrator 520 may execute a Web browser to access machine learning scenario management component 511 via HyperText Transfer Protocol and receive user interface 600 in return.

User interface 600 is associated with a pre-defined machine learning scenario “PREDICT_DELIVERY_DATE”. The machine learning scenario may be associated with prediction of a value for the target “DELIVERY_DATE” based on a SalesOrder object instance. The machine learning scenario may be customizable and therefore user interface 600 lists three different versions (i.e., Version 2, Version 4 and Version 9) of the machine learning scenario. Train control 610 may be selected to initiate training of a model based on the selected version. Prior trainings associated with the selected version (e.g., Version 9) are represented in trainings area 620.

Technical administrator 520 may indicate that the training should include training of a plurality of segment-specific models as described herein. A machine learning scenario may be associated with segment-specific multi-model training or with single model training by default, and such defaults may be overridden by technical administrator 520. In a case that segment-specific multi-model training is desired, such training may be configured via selection of multi-model configuration control 630.

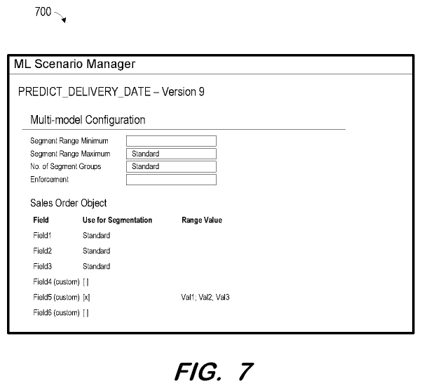

FIG. 7 illustrates multi-model configuration interface 700 invoked by selection of multi-model configuration control 630 according to some embodiments. Interface 700 allows technical administrator 520 to specify parameters used by multi-model manager component 513 to determine segments as described herein. For example, user interface 700 may allow a user to specify a maximum and minimum segment range, a number of segment groups, and an enforcement policy. According to some embodiments, the maximum segment range is equal to 50% of the number of training records and the minimum segment range is equal to 10% of the number of training records. These values correspond to variables M and N described below. The number of segment groups is dictated by the cardinality of the marked columns, as will also be described below.

Interface 700 also allows technical administrator 520 to customize how certain fields of the machine learning scenario's input object type will be used for segmentation. In the example, Field1, Field2 and Field3 of the SalesOrder object have been pre-defined as being for use in segmentation. This pre-definition may be accomplished via the metadata which defines the SalesOrder object as will be described below. Field4, Field5 and Field6 are custom fields which have been added to the SalesOrder object by customizing the metadata thereof. User interface 700 allows technical administrator 520 to specify whether such a custom field should be considered during the determination of segments. For those custom fields to be considered, user interface 700 also allows technical administrator 520 to specify particular values to which consideration of the custom field should be limited. The use of specific field values during the determination of segments will be described in detail below.

The above-described operation concerns segment-specific model training. In response, machine learning scenario management component 511 may instruct training manager 512 to request such training from training agent 531 of machine learning service 530. Training agent 531 then accesses the requested machine learning scenario 532 and manages training component 533 to train a model 534 conforming to the machine learning scenario 532 based on historical instance data of the input object type, which may be retrieved from application server 520.

Application server 540 may comprise an on-premise or cloud-based server providing an execution platform and services to applications such as application 542. Such services may be implemented by logic 544 and may include access to inference models via communication with training and inference management system 510. Logic 544 may provide a logical interface between application 542 and instance data 547 stored in storage 546. For example, semantic objects 545 may comprise metadata describing the semantics and structure of object instances stored within database tables of instance data 547. Application 542 therefore references the semantic objects and fields thereof, and logic 544 translates the references into operations on the underlying database tables of instance data 547. According to some embodiments, and as will be described in detail below, semantic objects 545 include data specifying which fields thereof should be considered during the determination of segments associated with the object.

Application 542 may comprise a Web application which receives HyperText Transfer Protocol requests from user 550 and returns data thereto. For example, application 542 may comprise a supply chain management application which user 550 accesses to perform demand forecasting, inventory management, etc. In response to input from user 550, application 542 accesses data from instance data 547 via logic 544, processes the data if needed, and provides user 550 with user interfaces including the data.

During operation, application 542 may issue a request to logic 544 to infer a value of a target based on instance data of a semantic object. Logic 544 creates a corresponding inference request and transmits the request to inference provider 515 of training and inference management system 510. Inference provider 515 uses segment registry 514 to determine a segment associated with the instance data of the inference request, and a trained model associated with the segment. Inference provider 515 then transmits a request to inference agent 535 of machine learning service 530 to infer the target value using the instance data and the determined trained model 534. The target value is then returned to logic 544 and requesting application 542.

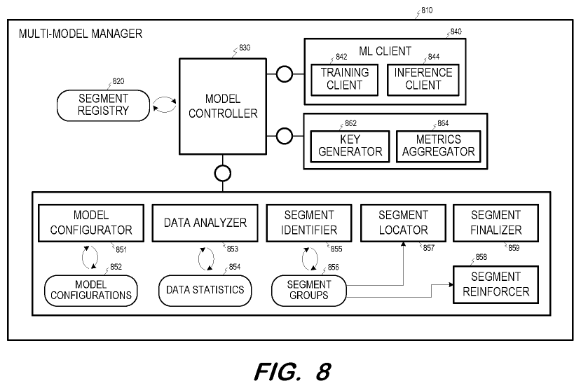

FIG. 8 is a block diagram of multi-model manager component 810 according to some embodiments. Multi-model manager component 810 may comprise an implementation of component 513 of FIG. 5. Generally, multi-model manager component 810 determines segments based on a training request and historical object instance data and maintains data representing the determined segments in registry 820. Multi-model manager component 810 also identifies a segment of segment registry 820 based on the instance data of an inference request.

As shown in FIG. 8, multi-model manager component 810 consists of multiple modules providing respective functions according to some embodiments. Model controller 830 act as a central driver which interacts with other modules. Model controller 830 maintains segment registry 820, which stores data identifying segments determined based on a training request and trained models corresponding to the segments.

Model configurator 851 processes any user-specific training configuration information and stores the information in model configuration persistency 852. Configuration information may include field markers, field-specific values or value ranges, segment grouping parameters, or the like. Model configurations 852 may be associated with multi-model training as described herein and with conventional single model training.

Data analyzer 853 analyzes the historical instance data used for training and generates statistics or other data based thereon. For example, unique values of each segment-related field may be retrieved from the historical instance data used based on semantic business object structure. Based on these values, data analyzer 853 may dynamically generate a Structured Query Language (SQL) query specific to each candidate segment group as described below. Data analyzer 853 may also determine the number of records, relevance and ranking. The data and/or statistics are written into data statistics persistency 854, for example as anonymized values. This data may be used for identifying and ranking segment groups as described below.

Based on data statistics 854, segment identifier 855 identifies segment groups 856 and ranks segment groups 856 according to data availability pattern, i.e., the ratio of data specific to a segment group to the overall training data. Segment identifier 855 may also eliminate invalid segment groups based on re-enforcement from previous trainings.

Segment finalizer 859 may consolidated identified segment groups into actual segments. For example, based on a list of segment groups, segment finalizer 859 determines segments based on segment group ranking, combinations of segment groups and limits within the segment range, user-configured mandatory segment groups, user-configured optional segment groups with data ranking, and re-enforced segment groups from previous training analysis. In the latter regard, segment reinforcer 858 tracks the training and inference patterns from previous training and inference activities to identify important segment groups.

Segment locator 857 identifies a segment-specific trained model on which a requested inference should be executed. The identification is based on matching keys (or optional dictionary keys) determined based on object instance data of a given inference request.

Key generator 862 is responsible for the generation of parent training request identification keys, identification keys for segment-specific trained models corresponding to each parent training request, segment matching keys, and segment dictionary keys. Examples of key-specific templates and patterns are provided below.

Machine learning service 530 may generate a segment-specific set of Key Performance Indicators, possible influencers and associated properties, and other programmed metrics for each trained segment-specific model. Metrics aggregator 864 aggregates these metrics into composite results associated with the parent training process based on common influencers across all the trained segment-specific models. The composite results are intended to reflect model influencers and may be analyzed by technical administrator 520 to deploy a trained model into productive usage by applications of application server 540.

As described above, logic 544 invokes an inference request via inference provider component 515 which internally connects to multi-model manager component 513 for delegating the inference request to a segment-specific inference model. Inference client 844 invokes an inference application programming interface (API) from machine learning service 530 for a determined segment-specific inference model, appended as a response to the original inference request.

Training client 846 invokes training-specific representational state transfer (REST) APIs of machine learning service 530 to trigger a new training process. The result of this training process will be one or more trained models as described herein.

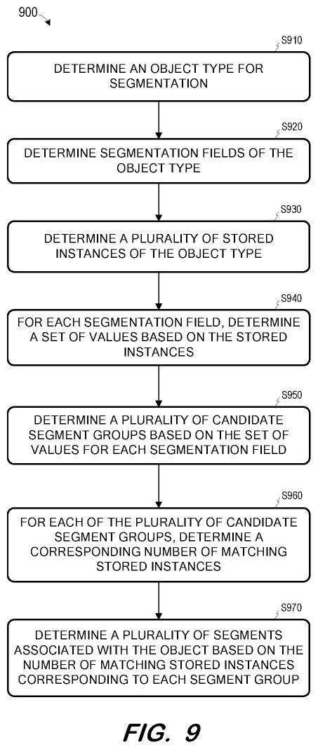

FIG. 9 is a flow diagram of process 900 to determine segments based on stored object instance data according to some embodiments. Process 900 may be performed by multi-model manager component 513 according to some embodiments.

At S910, an object type for segmentation is determined. The object type may be associated with a machine learning scenario for which training is requested. For example, a training request specifying a machine learning scenario may be received prior to S910. It is assumed that the request comprises a request for training of segment-specific models. According to some embodiments, the machine learning scenario is associated with training of segment-specific models by default. The machine learning scenario may be associated with an object type, a target, and other model training-related parameters. The request may also include configuration information such as that described above with respect to FIG. 7 and which is to be used during segment determination.

Segmentation fields of the object type are determined at S920. Segmentation fields are fields of the object whose values will be considered during segmentation of the object. A developer of a machine learning scenario 532 specifies the segmentation fields of an object type for a machine learning scenario by annotating the corresponding metadata of a semantic object 545 corresponding to the object type. According to some embodiments, semantic object 545 may be annotated with an “@MultiModelSegment” marker and this marker may be used by the multi-model manager component 513 to determine the segmentation fields of the corresponding object type at S920. For example:

```
@MultiModelSegment(enabled:‘[b]’)
Semantic_Object extends ISemanticObjects {
  @MultiModelSegment(dictionary:‘[b]’ marked:‘[b]’, index:‘[n]’)
  member_attribute type String;
  @MultiModelSegment(marked:‘[b]’, index:‘[n]’, target:‘[b]’)
  target_attribute type String;
}
// [b]-> Boolean − true or false.
// [n] -> Number, indicating index
```

The “dictionary” attribute is used to create dictionary keys for simplified lookup of a corresponding segment in the inference phase, as will be described below. The attribute may be False by default for all fields and enabled based on the use case. The “marked” attribute indicates that the marked field is to be considered during segment determination, and the “target” attribute is used to mark the attribute to be used for the target.

The following is an example of marking a SalesOrder object type based on the foregoing protocol:

```
@MultiModelSegment(enabled:‘true’)
SalesOrderSO extends ISemanticObjects{
  @MultiModelSegment(dictionary: ‘true’,marked:‘true’,index:‘1’)
  countryCode type String;
  @MultiModelSegment(marked:‘true’,index:‘2’)
  clientId type String;
  @MultiModelSegment(marked:‘true’,index:‘3’)
  orderType type String;
  @MultiModelSegment(marked:‘true’,index:‘4’, target:‘true’)
  discount type int;
  @MultiModelSegment(marked:‘true’,index:‘5’, target:‘true’)
  loyaltyPoints type int;
  orderValue type Currency;
  ..
  ..
  ..
}
```

In addition to the marked fields, S920 may comprise determination of any custom fields to be considered during segmentation. Such custom fields to be considered may be specified via configuration information associated with the training request and provided by technical administrator 520 as described with respect to FIG. 7.

Next, at S930, a plurality of stored instances of the object type are determined. For example, every instance (e.g., record) of a Sales Order is retrieved from instance data 547 of application server 540. The determined plurality of stored instances may alternatively be filtered in any suitable manner (e.g., all instances modified since xx/xx/xxxx, a last #xxxx modified instances).

For each segmentation field determined at S920, a set of values is determined based on the stored instances. That is, S920 comprises determining all values which are present in the determined plurality of stored instances for each segmentation field. Assuming the segmentation fields {Field1, Field2, Field4} of a given object type, and three stored object instances including respective values {Value1, ValueA, ValueX}, {Value1, ValueB, ValueX}, and {Value2, ValueC, ValueX}, the following sets would be determined at S940: Field1(Value1, Value2); Field2(ValueA, ValueB, ValueC); Field3(ValueX). It should be noted that S940 is performed with respect to determined segmentation fields of the object instances and not with respect to other fields (e.g., Field0, Field3).

A plurality of candidate segment groups are determined at S950 based on the sets of values determined at S940. The determination at S950 may comprise generating all possible combinations of the sets of field values determined at S940. Continuing the above example, the following candidate segment groups may be determined at S950:

Segment Group1 (Value1, ValueA, ValueX)

Segment Group2 (Value1, ValueB, ValueX)

Segment Group3 (Value1, ValueC, ValueX)

Segment Group4 (Value2, ValueA, ValueX)

Segment Group5 (Value2, ValueB, ValueX)

Segment Group6 (Value2, ValueC, ValueX)

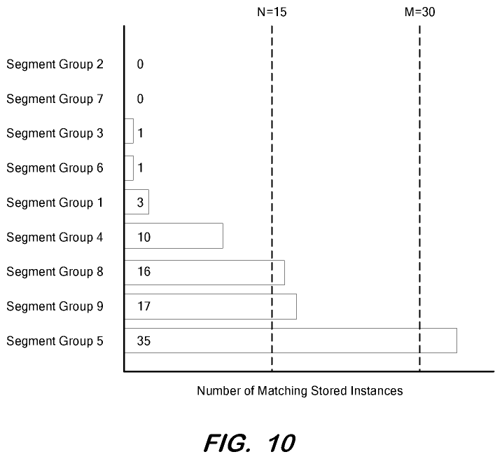

A number of matching stored instances for each candidate segment group is determined at S960. The number of matching stored instances may be determined by executing an SQL query for each of the segment groups and determining a number of records (i.e., instances) returned by each query. FIG. 10 illustrates a number of matching stored instances determined for each of nine candidate segment groups at S960 according to some embodiments.

A plurality of segments associated with the object are determined at S970 based on the number of matching stored instances. The determination at S970 may proceed according to any suitable logic that is or becomes known. In one example, given a segmentation range of N to M, each candidate segment group having greater than M matching stored instances is determined to represent a separate segment, all candidate segment groups having less than N matching stored instances are determined to represent a single segment, and candidate segment groups having between N and M matching stored instances are combined to form segments which each correspond to a total number of matching stored instances M. Segment range N to M for the requested multi-model training can be configured by technical administrator 520 as described with respect to FIG. 7.

With respect to FIG. 10, and with N=15 and M=30, Segment Group 2 and Segment Group 7 will not represent a segment as their corresponding number of matching stored instances is 0. Segment Group 3, Segment Group 6, Segment Group 1, and Segment Group 4 will be combined into a single segment, and Segment Group 5 will comprise a segment. Segment Group 8 and Segment Group 9 will be combined into a single segment since the total number of matching stored instances is 16+17=33≈30.

Each determined segment may be defined in segment registry 820 based on the field, value pairs of the segment groups which comprise the segment. A technical administrator may also define custom segments in segment registry 820 in addition to the segments determined by process 900. According to some embodiments, segments are identified by one or more unique identification keys and a matching key. The matching key, as will be described below, facilitates identification of a segment which matches an object instance of a subsequent inference request. The identification and matching keys of a segment may be generated as hash value of a predefined template combination of the fields and values of the segment group(s) which comprise the segment. For example:

Identification Key: Hash(Field_1→Name+””+ Field_1→segmentvalue,...,
Field_n→Name+””+Field_n→segmentvalue)
Matching Key: [Field_1→segmentvalue,..., Field_n→segmentvalue]

Additionally, each segment may be associated with a matching key template for creating a matching key based on instance data of an incoming inference request. A matching key may have multiple possibilities if a segment contains multiple segment groups (i.e., multiple qualifying field, value combinations), but a same corresponding matching template. For example:

Matching Template: Hash(Field_1, Field_2, . . . , Field_n)

In a specific example, a segment may consist of all records sharing the following tuples: [Country_Code:Germany, Client_Category:A , Payment_Status:Paid]. The Identification Key, Matching Key and Matching Template of such a segment may be stored as follows:

Identification Key: Hash(Country_Code:Germany, Client_Category:A ,
Payment_Status:Paid)
Matching Key: Hash(Germany+””+A+””+Paid)
Matching Template: [Country_Code, Client_Category, Payment_Status]

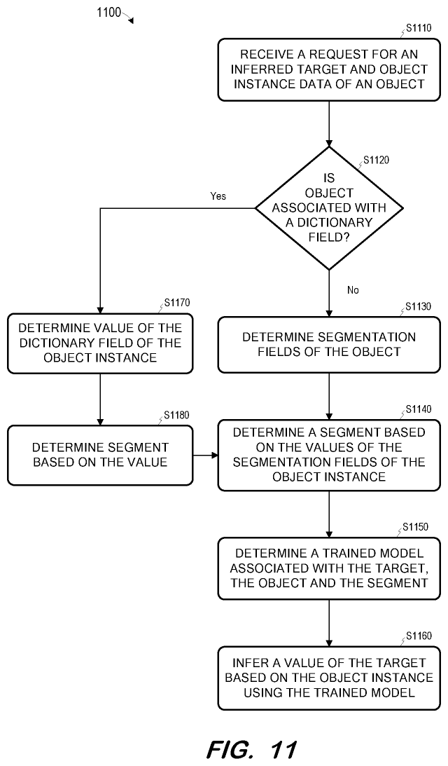

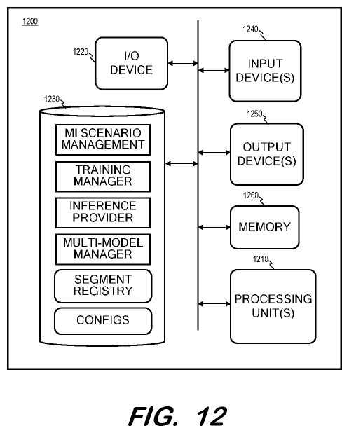

FIG. 11 is a flow diagram of a process to determine a segment and a corresponding trained inference model based on an inference request according to some embodiments. Initially, a request for an inferred value of a target is received at S1110.

The request includes instance data of an object, which consists of values associated with fields of the object. For example, the request may comprise a request for an inferred delivery date based on a particular sales order. The request may be received by inference provider 515 and include an instance stored in instance data 547.

At S1120 it is determined whether the object is associated with a dictionary field. The determination may be based on whether any attributes of the corresponding semantic object are marked as multi-model dictionary attributes, as described above. Flow proceeds to S1130 if it is determined that no attributes are marked as multi-model dictionary attributes.

Segmentation fields of the object are determined at S1130. Similarly to the determination at S1120, S1130 may comprise determination of attributes of the corresponding semantic object which are marked as multi-model-related attributes. S1130 may also include determination of the values of the object instance for each of the segmentation fields.

A segment is determined at S1140 based on the values of the segmentation fields of the object instance. In some embodiments, each segment associated with the object and target in registry 514 is identified. For each segment, the associated matching template is applied to the object instance to generate a key associated with the object instance. If the generated key matches the matching key associated with the segment in registry 514, the segment is determined to be associated with the object instance.

A trained model associated with the determined segment is determined at S1150. As described above, each segment represented in registry 514 may be associated with an identifier of a model which was trained based on instance data of that segment. S1150 may therefore simply comprise a lookup of the associated trained model identifier.

A value of the target is inferred based on the object instance using the trained model at S1160. Specifically, the values of the fields of the object instance are input to the trained model and the model outputs the inferred target value. In some embodiments, S1160 is performed by machine learning service 530 based on a request received from inference provider 515, where the request includes an identifier of the trained model and the data of the object instance.

Returning to S1120, flow proceeds to S1170 if it is determined that the object is associated with a dictionary field. S1120 may comprise a determination of one or more dictionary fields. At S1170, the value associated with each of the one or more dictionary fields of the object instance is determined. A segment associated with the value is determined at S1180. In this regard, segment registry 514 may associate each segment with values of the one or more dictionary fields. Accordingly, S1180 may comprise a lookup of a segment identifier based on the dictionary field values. Flow then continues to S1150 and proceeds as described above.

Many of the above-described operations utilize information maintained in a segment registry. For example, multi-model manager component 513 needs to associate a training request received from technical administrator 520 (i.e., a “parent” training request) with the segment-specific training requests generated therefrom. A segment registry according to some embodiments includes metadata information (status, key, matching key, matching key template, etc.) associated with various model segments, an identifier of a training process trigged for each segment, an identifier of a trained model associated with each segment, and an identifier of a parent training request associated with each segment. A segment registry according to some embodiments may include the following attributes:

Segment GUID—Unique GUID identifying an individual row (i.e., segment) of the registry.

Created On—Creation date and time, may be referenced to invalidate a row.

Status—Indicates whether segment is active, inactive or deleted

Segment Key—Key generated based on segment fields

Matching Key—Key expected from incoming inference request data

Matching Key Template—Template used to generate the matching key in the inference request data.

Training Model Id—Identifier received from machine learning service to uniquely identify a trained inference model associated with row.

Training Model Status—Availability status of trained inference model in machine learning service.

Segment Data Query—Query to identify object instances associated with the segment for training. The query may be passed training as a parameter to the process in the machine learning service, allowing the service to read/extract the instance data required for training a model specific to the segment.

Segment Index—The frequency of a segment with which incoming inference request are matched with the segment. The index may be used to reinforce determination of the segment in a next training process.

Object Name—Name of the semantic object associated with the segment and used during training and segmentation.

FIG. 12 is a block diagram of a hardware system providing training and inference management according to some embodiments. Hardware system 1200 may comprise a general-purpose computing apparatus and may execute program code to perform any of the functions described herein. Hardware system 1200 may be implemented by a distributed cloud-based server and may comprise an implementation of training and inference management system 510 in some embodiments. Hardware system 1200 may include other unshown elements according to some embodiments.

Hardware system 1200 includes processing unit(s) 1210 operatively coupled to I/O device 1220, data storage device 1230, one or more input devices 1240, one or more output devices 1250 and memory 1260. Communication device 1220 may facilitate communication with external devices, such as an external network, the cloud, or a data storage device. Input device(s) 1240 may comprise, for example, a keyboard, a keypad, a mouse or other pointing device, a microphone, knob or a switch, an infra-red (IR) port, a docking station, and/or a touch screen. Input device(s) 1240 may be used, for example, to enter information into hardware system 1200. Output device(s) 1250 may comprise, for example, a display (e.g., a display screen) a speaker, and/or a printer.

Data storage device 1230 may comprise any appropriate persistent storage device, including combinations of magnetic storage devices (e.g., magnetic tape, hard disk drives and flash memory), optical storage devices, Read Only Memory (ROM) devices, and RAM devices, while memory 1260 may comprise a RAM device.

Data storage device 1230 stores program code executed by processing unit(s) 1210 to cause server 1200 to implement any of the components and execute any one or more of the processes described herein. Embodiments are not limited to execution of these processes by a single computing device. Data storage device 1230 may also store data and other program code for providing additional functionality and/or which are necessary for operation of hardware system 1200, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code;
a processing unit to execute the processor-executable program code to cause the system to:
receive a training request comprising an object type and a target;
determine a plurality of segments associated with the object type based on a plurality of object instances of the object type;
for each of the plurality of segments, determine an associated plurality of object instances of the object type; and
for each of the plurality of segments, train a respective inference model to infer a value of the target based on the plurality of object instances associated with the segment.

2. A system according to claim 1, the processing unit to execute the processor-executable program code to cause the system to:
receive a first inference request comprising an object instance of the object type;
determine a first segment of the plurality of segments associated with the object instance;
determine a first one of the plurality of inference models associated with the first segment; and
determine to infer a first value of the target based on the first one of the plurality of inference models.

3. A system according to claim 2, the processing unit to execute the processor-executable program code to cause the system to:
receive a second inference request comprising a second object instance of the object type;
determine a second segment of the plurality of segments associated with the second object instance;
determine a second one of the plurality of inference models associated with the second segment; and
determine to infer a second value of the target based on the second one of the plurality of inference models.

4. A system according to claim 2, the processing unit to execute the processor-executable program code to cause the system to:
receive a second training request comprising a second object type and a second target;
determine a second plurality of segments associated with the second object type based on a second plurality of object instances of the second object type;
for each of the second plurality of segments, determine a second associated plurality of object instances of the second object type; and
for each of the second plurality of segments, train a respective inference model to infer a value of the second target based on the second plurality of object instances associated with the segment.

5. A system according to claim 1, the processing unit to execute the processor-executable program code to cause the system to:
receive a second training request comprising a second object type and a second target;
determine a second plurality of segments associated with the second object type based on a second plurality of object instances of the second object type;
for each of the second plurality of segments, determine a second associated plurality of object instances of the second object type; and
for each of the second plurality of segments, train a respective inference model to infer a value of the second target based on the second plurality of object instances associated with the segment.

6. A system according to claim 1, wherein determination of the segments comprises:
determination of a subset of fields of the object type as segmentation fields;
determination of values associated with the segmentation fields for each of the plurality of object instances of the object type; and
determination of the segments based on the determined values.

7. A method comprising:
receiving a training request comprising an object type and a target;
determining a plurality of segments associated with the object type based on a plurality of object instances of the object type;
for each of the plurality of segments, determining an associated plurality of object instances of the object type; and
for each of the plurality of segments, training a respective inference model to infer a value of the target based on the plurality of object instances associated with the segment.

8. A method according to claim 7, further comprising:
receiving a first inference request comprising an object instance of the object type;
determining a first segment of the plurality of segments associated with the object instance;
determining a first one of the plurality of inference models associated with the first segment; and
determining to infer a first value of the target based on the first one of the plurality of inference models.

9. A method according to claim 8, further comprising:
receiving a second inference request comprising a second object instance of the object type;
determining a second segment of the plurality of segments associated with the second object instance;
determining a second one of the plurality of inference models associated with the second segment; and
determining to infer a second value of the target based on the second one of the plurality of inference models.

10. A method according to claim 8, further comprising:
receiving a second training request comprising a second object type and a second target;
determining a second plurality of segments associated with the second object type based on a second plurality of object instances of the second object type;
for each of the second plurality of segments, determining a second associated plurality of object instances of the second object type; and
for each of the second plurality of segments, training a respective inference model to infer a value of the second target based on the second plurality of object instances associated with the segment.

11. A method according to claim 7, further comprising:
receiving a second training request comprising a second object type and a second target;
determining a second plurality of segments associated with the second object type based on a second plurality of object instances of the second object type;
for each of the second plurality of segments, determining a second associated plurality of object instances of the second object type; and
for each of the second plurality of segments, training a respective inference model to infer a value of the second target based on the second plurality of object instances associated with the segment.

12. A method according to claim 7, wherein determining the segments comprises:
determining a subset of fields of the object type as segmentation fields;
determining values associated with the segmentation fields for each of the plurality of object instances of the object type; and
determining the segments based on the determined values.

13. A non-transitory medium storing processor-executable program code executable by a processing unit of a computing system to cause the computing system to:
receive a training request comprising an object type and a target;
determine a plurality of segments associated with the object type based on a plurality of object instances of the object type;
for each of the plurality of segments, determine an associated plurality of object instances of the object type; and
for each of the plurality of segments, train a respective inference model to infer a value of the target based on the plurality of object instances associated with the segment.

14. A medium according to claim 13, processor-executable program code executable by a processing unit of a computing system to cause the computing system to:
receive a first inference request comprising an object instance of the object type;
determine a first segment of the plurality of segments associated with the object instance;
determine a first one of the plurality of inference models associated with the first segment; and
determine to infer a first value of the target based on the first one of the plurality of inference models.

15. A medium according to claim 14, processor-executable program code executable by a processing unit of a computing system to cause the computing system to:
receive a second inference request comprising a second object instance of the object type;
determine a second segment of the plurality of segments associated with the second object instance;
determine a second one of the plurality of inference models associated with the second segment; and
determine to infer a second value of the target based on the second one of the plurality of inference models.

16. A medium according to claim 14, the processor-executable program code executable by a processing unit of a computing system to cause the computing system to:
receive a second training request comprising a second object type and a second target;
determine a second plurality of segments associated with the second object type based on a second plurality of object instances of the second object type;
for each of the second plurality of segments, determine a second associated plurality of object instances of the second object type; and
for each of the second plurality of segments, train a respective inference model to infer a value of the second target based on the second plurality of object instances associated with the segment.

17. A medium according to claim 13, the processor-executable program code executable by a processing unit of a computing system to cause the computing system to:
receive a second training request comprising a second object type and a second target;
determine a second plurality of segments associated with the second object type based on a second plurality of object instances of the second object type;
for each of the second plurality of segments, determine a second associated plurality of object instances of the second object type; and
for each of the second plurality of segments, train a respective inference model to infer a value of the second target based on the second plurality of object instances associated with the segment.

18. A medium according to claim 13, wherein determination of the segments comprises:
determination of a subset of fields of the object type as segmentation fields;
determination of values associated with the segmentation fields for each of the plurality of object instances of the object type; and
determination of the segments based on the determined values.
